(19) United States
(12) Patent Application Publication
(10) Pub. No.: US 2026/0252486 A1
(43) Pub. Date: Aug. 27, 2026

(54) DATA ROUTING AND MEMORY BLOCK MANAGEMENT IN A SUB-BLOCK MEMORY SYSTEM

(71) Applicant: Sandisk Technologies, Inc., Milpitas, CA (US)

(72) Inventors: Rajitha Vemuri, Bengaluru (IN); Akash Nigam, Bengaluru (IN); Ramanathan Muthiah, Bengaluru (IN)

(21) Appl. No.: 19/065,882

(22) Filed: Feb. 27, 2025

(51) Int. Cl. G06F 12/02

(52) U.S. Cl. CPC G06F 12/0253; G06F 12/0246; G06F 2212/1044; G06F 2212/7205

(57) ABSTRACT

A data storage device includes a sub-block management system that analyzes memory blocks in a pool of memory blocks that have been identified as candidates for a garbage collection operation. Each memory block in the pool includes at least two sub-blocks. As part of the analysis, the sub-block management system identifies the sub-block having the lowest validity count. The sub-block management system also determines a validity count of a sister sub-block that is associated with the identified sub-block. If a difference between the validity counts is within a validity count difference threshold, the sub-block management system selects both sub-blocks for the garbage collection operation. However, if the difference in the validity counts exceeds the validity count difference threshold, the sub-block management system selects only the identified sub-block for the garbage collection operation.

### BACKGROUND

As data storage devices evolve and as storage capacity increases, some data storage devices partition memory blocks into sub-blocks. There are many advantages to using sub-blocks in data storage devices. For example, garbage collection operations and wear leveling operations on sub-blocks are more efficient when compared with similar operations that are performed on standard memory blocks. Specifically, because sub-blocks are typically half the size of standard memory blocks, more memory block budget possibilities are available when compared with standard memory blocks.

The use of sub-blocks also reduces write amplification. For example, because garbage collection operations are directed to smaller sub-blocks, an amount of valid data that is copied and subsequently moved is also reduced when compared with standard memory blocks. During error correction and bad block management operations, the smaller granularity of sub-blocks, when compared with standard memory blocks, improves memory block usage efficiency.

While there are advantages to using sub-blocks, there are also some disadvantages. For example, during a garbage collection operation, each sub-block is typically erased independently from other sub-blocks – even its sister sub-block. Thus, if a latency of erasing a first sub-block is L1 and the latency of erasing a second sub-block is L2, the total latency is L1 + L2, which is substantially higher when compared to erasing a standard memory block.

Accordingly, it would be beneficial for a data storage device to benefit from the advantages of using sub-blocks, such as those outlined above, without suffering from the disadvantages of using sub-blocks.

The present disclosure describes a sub-block management system for a data storage device. In an example, the sub-block management system is operable to analyze one or more memory blocks in a pool of memory blocks that have been identified as candidates for a garbage collection operation. The sub-block management system analyzes the memory blocks in the pool of memory blocks to identify a sub-block that has the lowest validity count. The sub-block management system then determines a validity count of the sub-block (referred to herein as the sister sub-block) that is associated with the sub-block having the lowest validity count.

The sub-block management system determines a difference between the validity count associated with the sister sub-block and the validity count associated with the sub-block having the lowest validity count. If the difference between the validity count of the sister sub-block and the validity count of the sub-block having the lowest validity count is within a validity count difference threshold, the sub-block management system selects both sub-blocks for the garbage collection operation. However, if the difference in the validity counts exceeds the validity count difference threshold, the sub-block management system selects only the identified sub-block for the garbage collection operation.

The sub-block management system also determines one or more characteristics of data that is associated with the sub-block having the lowest validity count and/or the sister sub-block. When the data associated with the sub-block having the lowest validity count (and/or the data associated with the sister sub-block) is relocated as part of the garbage collection operation, the sub-block management system selects a destination memory block based, at least in part, on the one or more characteristics of the data.

For example, if the data to be relocated as part of the garbage collection operation is sequential data, the sub-block management system selects a destination memory block that also stores sequential data. However, if the data to be relocated is random data, the sub-block management system selects a destination memory block that stores random data. As a result, the overhead for subsequent garbage collection operations will be reduced when compared with current solutions.

Accordingly, examples of the present disclosure describe a method that includes identifying a plurality of memory blocks that have been selected for a garbage collection operation. In an example, each memory block of the plurality of memory blocks is divided into two or more sub-blocks. At least one memory block from the plurality of memory blocks is selected for the garbage collection operation. A first validity count associated with a first sub-block of the at least one memory block is determined and a second validity count associated with a second sub-block of the at least one memory block is determined. A determination is then made as to whether a difference between the first validity count associated with the first sub-block and the second validity count associated with the second sub-block is within a validity count difference threshold. The garbage collection operation is performed on the first sub-block and the second sub-block when the difference between the first validity count associated with the first sub-block and the second validity count associated with the second sub-block is within the validity count difference threshold.

Examples also describe a data storage device that includes at least one controller and a sub-block management system associated with the at least one controller. The sub-block management system is operable to select a memory block for a relocation operation. In an example, the memory block that is selected is part of a pool of memory blocks that have been identified as candidates for the relocation operation. The sub-block management system also determines a first validity count associated with a first sub-block of the memory block and determines a second validity count associated with a second sub-block of the memory block. The sub-block management system also determines a difference between the first validity count and the second validity count and performs the relocation operation on one of the first sub-block and the second sub-block when a difference between the first validity count and the second validity count exceeds a validity count difference threshold.

Still other examples describe a data storage device that includes means for selecting a memory block from a pool of memory blocks for a garbage collection operation. In an example, the data storage device also includes means for determining a first validity count associated with a first sub-block of the memory block and means for determining a second validity count associated with a second sub-block of the memory block. The data storage device also includes means for determining a difference between the first validity count and the second validity count. The data storage device also includes means for performing the garbage collection operation on the first sub-block and the second sub-block when a difference between the first validity count and the second validity count is within a validity count difference threshold.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram of a system that includes a host device and a data storage device according to an example.

FIG. 2A illustrates how a memory device includes a number of memory blocks according to an example.

FIG. 2B illustrates how a memory block includes one or more pages according to an example.

FIG. 3 illustrates a pool of memory blocks that have been identified as candidates for a garbage collection operation and/or a relocation operation according to an example.

FIG. 4 illustrates how one or more characteristics of data associated with a source memory block is used to select a destination memory block according to an example.

FIG. 5 illustrates a method for performing a garbage collection operation on one or more sub-blocks of a memory block according to an example.

FIG. 6 illustrates a method for selecting a destination memory block as part of a garbage collection operation according to an example.

FIG. 7 is a perspective view of a storage device that includes three-dimensional (3D) stacked non-volatile memory according to an example.

FIG. 8 is a block diagram of a storage device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

As previously described, memory blocks in some data storage devices are partitioned or divided into sub-blocks. As the storage capacity of these data storage devices increases, the use of sub-blocks allows for efficient data management and offer a number of advantages. For example and with respect to garbage collection operations, instead of erasing the entire memory block, each sub-block of a memory block can be erased independently. This can improve write performance and endurance of the data storage device. In another example, the use of sub-blocks reduces write amplification as less data needs to be moved around during relocation operations, which increases efficiency.

In yet other examples, the use of sub-blocks improves wear leveling as any wear can spread across the various memory blocks more effectively when compared with standard memory blocks. Additionally, the use of sub-blocks reduces write amplification since smaller portions of a memory block can be copied, erased and subsequently rewritten.

While the use of sub-blocks offer the above-recited advantages, the use of sub-blocks also has disadvantages. For example, during a garbage collection operation, each sub-block is erased independently from other sub-blocks – even if each sub-block is associated with, or part of, the same memory block. Thus, if each sub-block of a single memory block is to be erased, the latency is almost double that of erasing a single memory block. For example and as previously described, if a latency of erasing a first sub-block is L1 and the latency of erasing a second sub-block is L2, the total latency is L1 + L2 which is substantially higher than the latency of erasing a standard memory block.

To address the above, the present disclosure describes a data storage device having a sub-block management system. As will be explained in greater detail herein, the sub-block management system is operable to identify and/or analyze one or more memory blocks in a pool of memory blocks that have been identified as candidates for a garbage collection operation. As part of this analysis, the sub-block management system identifies a sub-block in the pool of memory blocks that has the lowest validity count. The sub-block management system then determines a validity count of the sister sub-block (e.g., the sub-block that is associated with the same memory block and/or is associated with the sub-block that is identified as having the lowest validity count).

If the validity count of the sister sub-block is within a validity count difference threshold, both sub-blocks undergo the garbage collection operation. However, if the difference between the validity counts exceeds the validity count difference threshold, the identified sub-block undergoes the garbage collection operation while the sister sub-block does not.

The sub-block management system also determines one or more characteristics of data that is to be relocated as part of the garbage collection operation. The sub-block management system then selects a destination memory block based, at least in part, on the one or more characteristics. For example, if the data to be relocated is sequential data, the sub-block management system selects a destination memory block that stores sequential data. However, if the data to be relocated is random data, the sub-block management system selects a destination memory block that stores random data. As a result, the overhead for subsequent garbage collection operations will be reduced

Accordingly, many technical benefits may be realized including, but not limited to, reducing unnecessary garbage collection operations by combining sub-blocks and reducing subsequent garbage collection operations by combining data of similar types during relocation operations which increases the performance of the data storage device.

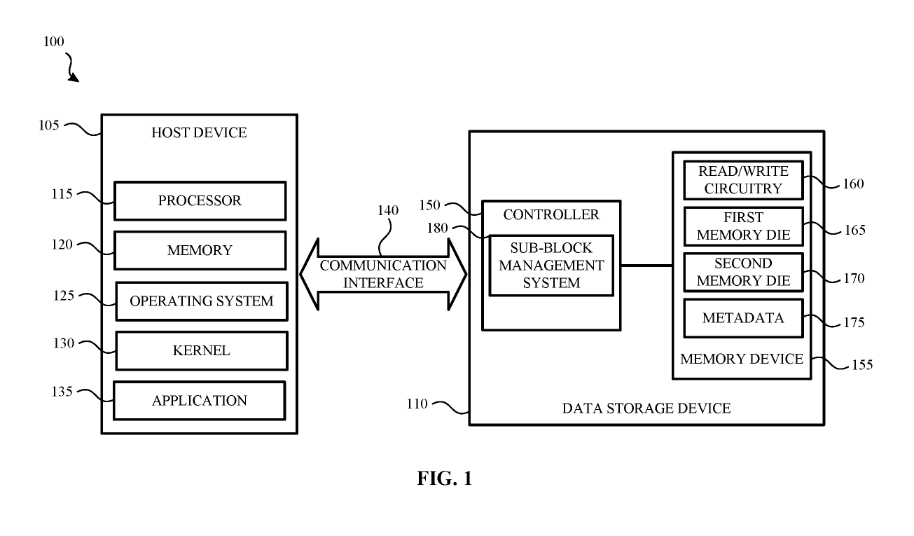

These benefits, along with other examples, will be shown and described in greater detail with respect to FIG. 1 – FIG. 8.

FIG. 1 is a block diagram of a system 100 that includes a host device 105 and a data storage device 110 according to an example. In an example, the host device 105 includes a processor 115 and a memory 120 (e.g., main memory). The memory 120 includes or is otherwise associated with an operating system 125, a kernel 130 and/or an application 135.

The processor 115 can execute various instructions, such as, for example, instructions from the operating system 125 and/or the application 135. The processor 115 includes circuitry such as a microcontroller, a Digital Signal Processor (DSP), an Application-Specific Integrated Circuit (ASIC), a Field Programmable Gate Array (FPGA), hard-wired logic, analog circuitry and/or various combinations thereof. In an example, the processor 115 includes a System on a Chip (SoC).

In an example, the memory 120 is used by the host device 105 to store data used, or otherwise executed by, the processor 115. Data stored in the memory 120 includes instructions provided by the data storage device 110 via a communication interface 140. The data stored in the memory 120 also includes data used to execute instructions from the operating system 125 and/or one or more applications 135. The memory 120 may be a single memory or may include multiple memories, such as, for example one or more non-volatile memories, one or more volatile memories, or a combination thereof.

In an example, the operating system 125 creates a virtual address space for the application 135 and/or other processes executed by the processor 115. The virtual address space maps to locations in the memory 120. The operating system 125 also includes or is otherwise associated with a kernel 130. The kernel 130 includes instructions for managing various resources of the host device 105 (e.g., memory allocation), handling read and write requests and so on.

The communication interface 140 communicatively couples the host device 105 and the data storage device 110. The communication interface 140 may be a Serial Advanced Technology Attachment (SATA), a PCI express (PCIe) bus, a Small Computer System Interface (SCSI), a Serial Attached SCSI (SAS), Ethernet, Fibre Channel, or Wi-Fi. As such, the host device 105 and the data storage device 110 need not be physically co-located and may communicate over a network such as a Local Area Network (LAN) or a Wide Area Network (WAN), such as the internet. In addition, the host device 105 may interface with the data storage device 110 using a logical interface specification such as Non-Volatile Memory express (NVMe) or Advanced Host Controller Interface (AHCI).

The data storage device 110 includes at least one controller 150 and a memory device 155. In an example, the controller 150 is communicatively coupled to the memory device 155. The memory device 155 includes one or more memory dies (e.g., a first memory die 165 and a second memory die 170). Although memory dies are specifically mentioned, the memory device 155 may include any non-volatile memory device, storage device, storage elements or storage medium including NAND flash memory cells and/or NOR flash memory cells.

The memory cells can take the form of solid-state (e.g., flash) memory cells and can be one-time programmable, few-time programmable, or many-time programmable. Additionally, the memory cells may be single-level cells (SLCs), multi-level cells (MLCs), triple-level cells (TLCs), quad-level cells (QLCs), penta-level cells (PLCs), and/or use any other memory technologies. In one example, the memory cells are arranged in a two-dimensional configuration. In another example, the memory cells are arranged in a three-dimensional configuration.

In an example, the data storage device 110 is attached to or embedded within the host device 105. In another example, the data storage device 110 is implemented as an external device or a portable device that can be communicatively or selectively coupled to, and removed from, the host device 105. In yet another example, the data storage device 110 is a component (e.g., a solid-state drive (SSD)) of a network accessible data storage system, a network-attached storage system, a cloud data storage system, or the like.

As indicated above, the memory device 155 of the data storage device 110 includes a first memory die 165 and a second memory die 170. Although two memory dies are shown, the memory device 155 may include any number of memory dies (e.g., one memory die, two memory dies, eight memory dies, or another number of memory dies).

The memory device 155 also includes support circuitry. In an example, the support circuitry includes read/write circuitry 160. The read/write circuitry 160 supports the operation of the memory dies of the memory device 155. Although the read/write circuitry 160 is depicted as a single component, the read/write circuitry 160 may be divided into separate components, such as, for example, read circuitry and write circuitry. The read/write circuitry 160 may be external to the memory dies of the memory device 155. In another example, one or more of the memory dies may include corresponding read/write circuitry 160 that is operable to read data from and/or write data to storage elements within one individual memory die independent of other read and/or write operations on any of the other memory dies.

In an example, one or more of the first memory die 165 and the second memory die 170 include one or more memory blocks and each memory block includes one or more memory cells. A block of memory cells is the smallest number of memory cells that are physically erasable together. In an example and for increased parallelism, each of the memory blocks may be operated or organized in larger memory blocks or metablocks. For example, a memory block from different memory dies may be logically linked together to form a metablock.

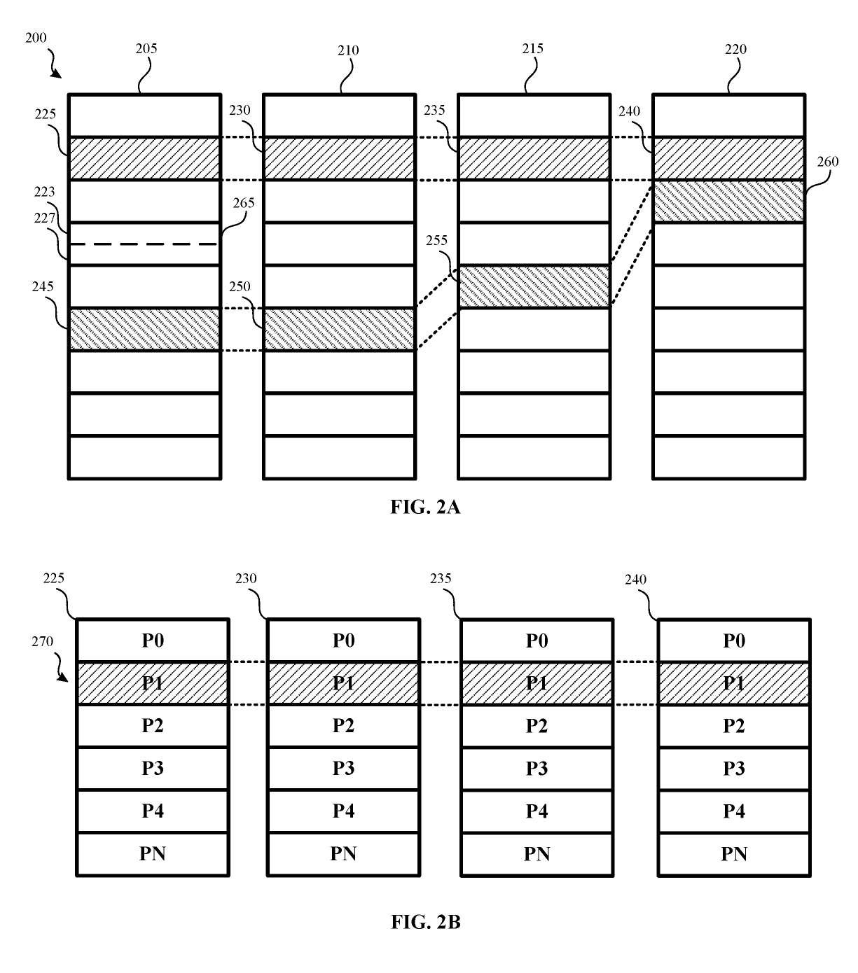

FIG. 2A illustrates how a memory device 200 includes a number of memory blocks according to an example. In this example, the memory device 200 (e.g., a storage element, a memory die, a non-volatile memory device) includes four planes or sub-arrays (e.g., a first plane 205, a second plane 210, a third plane 215, and a fourth plane 220). In an example, the planes are integrated on a single memory die. In another example, the planes are provided on two different memory dies (e.g., two planes on each memory die). In yet another example, the planes are provided on four separate memory dies. Although four planes are shown and described, the memory device 200 may have any number of planes and/or memory dies.

In an example, each plane is divided into memory blocks consisting of memory cells. As shown in FIG. 2A, the rectangles represent a memory block, such as memory block 225, memory block 230, memory block 235 and memory block 240. There may be any number of memory blocks in each plane of the memory device 200. In an example, each memory block is a unit of erase and is sometimes referred to as an erase block. For example, memory block 225, memory block 230, memory block 235 and memory block 240 include a minimum number of memory cells that are erased together.

In an example, a memory block can be divided or partitioned into sub-blocks. For example, a memory block 265 can be divided into a first sub-block 223 and a second sub-block 227. In such an example, each sub-block will be associated with various physical wordlines and/or logical wordlines.

For example, if the memory block 265 has 216 wordlines, the first sub-block 223 will be comprised of physical wordlines 0-107 while the second sub-block 227 will be comprised of physical wordlines 108-215. The first sub-block 223 and the second sub-block 227 are also associated with logical wordlines.

In an example, various memory blocks are logically linked or grouped together (e.g., using a table in or otherwise accessible by the controller 150 (FIG. 1)) to form a metablock. A metablock is written to, read from and/or erased as a single unit. For example, memory block 225, memory block 230, memory block 235 and memory block 240 form a first metablock while memory block 245, memory block 250, memory block 255 and memory block 260 form a second metablock. The memory blocks used to form a metablock need not be restricted to the same relative locations within their respective planes.

In examples in which memory blocks are divided into sub-blocks, due to the way in which the logical wordlines of each sub-block are mapped to the physical wordlines of the memory block, a first sub-block of one memory die (or of one plane of one memory die) can be linked to other first sub-blocks of other memory dies (or other planes of the same memory die) when forming a metablock. Likewise, second sub-blocks of one memory die can be linked to other second sub-blocks of other memory dies when forming a metablock.

In an example, each memory block is divided, for operational purposes, into pages of memory cells. For example and referring to FIG. 2B, FIG. 2B illustrates how a memory block includes one or more pages according to an example. For example, the memory cells of memory block 225, memory block 230, memory block 235 and memory block 240 are divided into N different pages (shown as P0 – PN). Although a specific number of pages are shown in FIG. 2B, a memory block may have any number of pages of memory cells within each memory block.

In an example, a page is a unit of data programming within the memory block. Each page includes the minimum amount of data that can be programmed at one time. The minimum unit of data that can be read at one time may be less than a page. For example, each page is further dividable into segments or units and each segment includes the fewest number of memory cells that may be written to at one time as a basic programming operation.

A metapage 270 is illustrated in FIG. 2B as being formed of one physical page from each of memory block 225, memory block 230, memory block 235 and memory block 240. In the example, shown, the metapage 270 includes page P1 in each of the four memory blocks. However, the pages of the metapage 270 need not have the same relative position within each of the memory blocks. A metapage 270 may be the maximum unit of programming within a memory block.

The memory blocks disclosed in FIG. 2A – FIG. 2B are referred to herein as physical memory blocks because they relate to groups of physical memory cells as discussed above. As used herein, a logical memory block is a virtual unit of address space defined to have the same size as a physical memory block. Each logical memory block includes a range of logical memory block addresses (LBAs) that are associated with data received from a host. The LBAs are then mapped to one or more physical memory blocks in the data storage device 110 where the data is physically stored.

As indicated above, each memory block includes any number of memory cells. The design, size, and organization of a memory block depends on the architecture, design, and application desired for each memory die. In an example, the memory block includes a contiguous set of memory cells that share a plurality of wordlines and bit lines.

Referring back to FIG. 1, as previously described, the data storage device 110 includes at least one controller 150. Although a single controller 150 is shown and described, the data storage device 110 can include multiple controllers. In such an example, a first controller executes a first operation, or set of operations, and the second controller executes a second operation, or set of operations. In an example, the first set of operations and the second set of operations are executed on the same memory dies. In other examples, the first set of operations is executed on a first memory die or a first set of memory dies and the second set of operations is executed on a second memory die or a second set of memory dies.

The controller 150 is communicatively coupled to the memory device 155 via a bus, an interface or other communication circuitry. In an example, the communication circuitry includes one or more channels to enable the controller 150 to communicate with the first memory die 165 and/or the second memory die 170 of the memory device 155. In another example, the communication circuitry includes multiple distinct channels which enables the controller 150 to communicate with the first memory die 165 independently and/or in parallel with the second memory die 170 of the memory device 155.

The controller 150 receives data and/or instructions from the host device 105. The controller 150 also sends data to the host device 105. For example, the controller 150 sends data to and/or receives data from the host device 105 via the communication interface 140. The controller 150 also sends data and/or commands to, and/or receive data from, the memory device 155.

The controller 150 sends data, and a corresponding write command, to the memory device 155 to cause the memory device 155 to store data at a specified address of the memory device 155. In an example, the write command specifies a physical address of a portion of the memory device 155. The controller 150 also sends data and/or commands associated with one or more background scanning operations, garbage collection operations, and/or wear leveling operations.

The controller 150 also sends one or more read commands to the memory device 155. In an example, the one or more read commands specify the physical address of a portion of the memory device 155 at which the data is stored. The controller 150 also tracks the number of program/erase cycles or other programming operations that have been performed on or by the memory device and/or the memory dies of the memory device 155.

The controller 150 also includes, or is otherwise associated with, a sub-block management system 180. In an example, the sub-block management system 180 is a packaged functional hardware unit designed for use with other components/systems. In another example, the sub-block management system 180 is a portion of a program code (e.g., software or firmware) executable by, the controller 150, a processor or processing circuitry. In yet another example, the sub-block management system 180 is a self-contained hardware and/or software component/system that interfaces with other components and/or systems. Although the sub-block management system 180 is shown as being part of the controller 150, the sub-block management system 180 may be separate from the controller 150.

The sub-block management system 180 is operable to identify a number of memory blocks, or a pool of memory blocks, that are candidates for a garbage collection operation and/or a relocation operation. In an example, any suitable method may be used to identify memory blocks that are candidates for the garbage collection operation and/or the relocation operation.

For example, each memory block in the pool of memory blocks has or is otherwise associated with a validity count that indicates an amount of valid data stored by the memory block. The lower the validity count, the less amount of valid data stored by the memory block. As a result, during the garbage collection operation, less data needs to be read from the memory block and relocated to a destination memory block.

Additionally, each memory block in the pool of memory blocks includes two or more sub-blocks. For example, each memory block of each of the first memory die 165 and the second memory die 170 includes a first sub-block and a second sub-block. In this example, each sub-block is associated with its own validity count.

For example, a first sub-block of the memory block has a validity count of X while the second sub-block of the memory block has a validity count of Y. X and Y may be the same value or different values. In another example, X may be slightly higher than Y or significantly higher than Y. Alternatively, Y may be slightly higher than X or significantly higher than X.

When the sub-block management system 180 and/or the controller 150 determines to initiate a garbage collection operation and/or a relocation operation (e.g., in response to a received command or from some other determination), the sub-block management system 180 analyzes the pool of memory blocks to determine or identify which sub-block has the lowest validity count.

When the sub-block with the lowest validity count is identified, the sub-block management system 180 determines the validity count of the sub-block (e.g., the sister sub-block) associated with the identified sub-block. If a difference between the validity count of the sister sub-block and the identified sub-block is within a validity count difference threshold, the sub-block management system causes the garbage collection operation and/or the relocation operation to be performed on the entire memory block (e.g., the identified sub-block and the sister sub-block).

In an example, the validity count difference threshold may be any suitable number or value. However, if the difference in the validity count between the two sub-blocks is too great (meaning one of the sub-blocks stores a large amount of valid data when compared with the other sub-block) any latency gains that would be achieved by performing the garbage collection operations described herein would be potentially negated by having to move a large amount of valid data from one of the sub-blocks to a destination memory block.

Referring back to the example, if the sub-block management system 180 determines that the difference between validity counts exceeds the validity count difference threshold, the sub-block management system 180 causes the garbage collection operation and/or the relocation operation to be performed only on the sub-block that was identified as having the lowest validity count.

In another example, and depending on an operating state of the data storage device 110, the sub-block management system 180 may analyze the pool of memory blocks to determine which sub-blocks have validity counts within the validity count difference threshold. The sub-block management system 180 may select these memory blocks (or sub-blocks) for the garbage collection operation and/or the relocation operation – even if one of the sub-blocks does not have the lowest validity count when compared with other sub-blocks. For example, if the data storage device 110 has under a threshold amount of available space, the sub-block management system 180 may determine that it would be more beneficial free up an entire memory block in a garbage collection operation when compared with a single sub-block.

When performing the garbage collection operation and/or the relocation operation, the sub-block management system 180 may also determine one or more characteristics about the data stored in the identified sub-block (and/or its sister sub-block when the garbage collection operation and/or the relocation operation will be performed on both sub-blocks). The sub-block management system 180 will select a destination memory block based, at least in part, on the one or more characteristics.

For example, if the identified sub-block stores random data, the sub-block management system 180 may identify a destination memory block that also stores random data. In another example, if the identified sub-block stores sequential data, the sub-block management system 180 may identify a destination memory block that also stores random data.

Likewise, if the identified sub-block stores hot data (e.g., data this is frequently accessed), the sub-block management system 180 may identify a destination memory block that also stores hot data. In still yet another example, if the identified sub-block stores cold data (e.g., data that is infrequently accessed), the sub-block management system 180 identifies a destination memory block that also stores cold data. In yet another example, the characteristic may be a stream ID. Although specific examples are given, other characteristics may be used.

In addition to the examples set forth above, the sub-block management system 180 may select destination memory blocks in which one of the sub-blocks of the destination memory block is already full of data or has stored over a threshold amount of data (e.g., 70% full, 80% full 90% full). If a memory block meeting one or more of the characteristics described above cannot be identified, the sub-block management system 180 will select an empty destination memory block. Using this approach, garbage collection overhead will be reduced during subsequent garbage collection operations when compared with current solutions.

In another example, the host device 105 is a flexible data placement (FDP) host device 105. In such an example, the host device 105 may determine or identify whether to erase a full memory block or whether to erase one or more sub-blocks individually. For example, the sub-block management system 180 provides sub-block information and/or erase hints (e.g., valid fragment count information, access frequency information latency information) to the host device 105. The host device 105 uses the information to decide to whether to erase a particular memory block as a full memory block or as one or more sub-blocks. For example, the sub-block management system may determine the erase type (e.g., whether to erase a full memory block or a sub-block) using the various operations and information described herein. Although a FDP host device is described, the same concepts can be extended to other OCSSD systems such as a zoned namespace system (ZNS).

In yet another example, the host device 105 can instruct the sub-block management system 180 to handle sub-blocks as individual memory blocks. In another example, the host device can consider sub-block as a combination of full memory blocks based on the type of the data that the host device 105 is routing to the data storage device 110.

For example, if the host device 105 determines that data to be stored in the data storage device 110 is long sequential writes, the host device 105 can combine sub-blocks into a single block and also provide instructions to the sub-block management system 180 to erase the sub-blocks together and/or program the data accordingly. This improves quality of service (QoS) of the data storage device 110 when compared with current solutions as only one erase is involved in a full memory block. For other data sets, the host device 105 may treat the data as individual sub-blocks. As such, the host device 105 has the flexibility to use the smaller sub-blocks but reclaim various units in a reclaim group.

In another example, the host device 105 shares access frequency and/or access latency information to the data storage device 110 and/or the sub-block management system 180. In response to receiving this information, the sub-block management system 180 uses the provided information or hints to identify an access frequency of the data and determine the type of sub-block that is to be used to store data from the host device 105.

Thus, when the sub-block management system 180 evaluates some data stream to be “hot” (e.g., based on access frequency hints from the host device 105), the sub-block management system 180 routes the data into one or more memory blocks (e.g., erase and use a block as a full memory block) or sub-blocks (erase and use the memory block as sub-block). For example, since the hot data has a good chance of getting trimmed and needing relocation, it may be advantageous to keep the data in smaller sub-blocks. This will reduce garbage collection operations when compared to using full memory blocks.

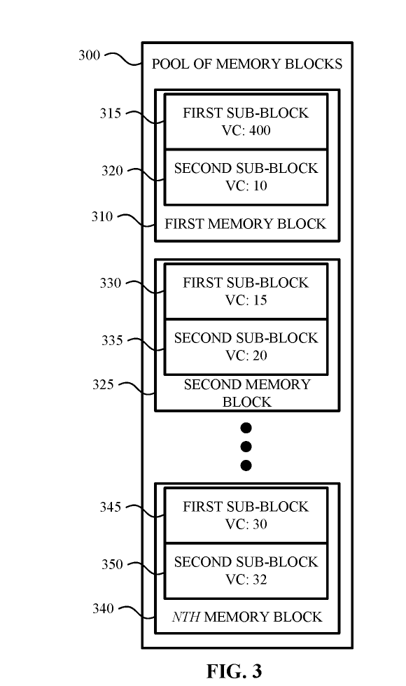

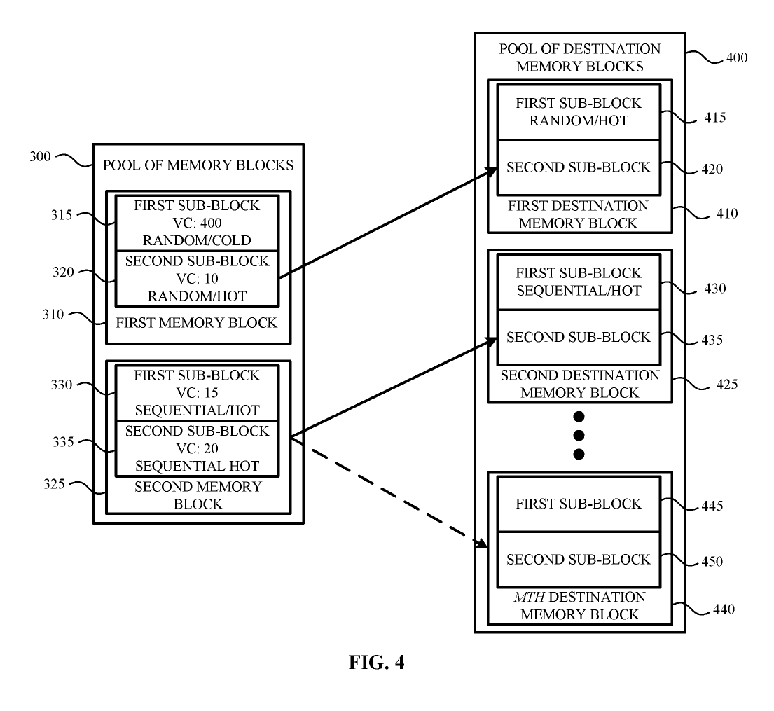

FIG. 3 illustrates a pool of memory blocks 300 that have been identified as candidates for a garbage collection operation and/or a relocation operation according to an example. In an example, each of the memory blocks in the pool of memory blocks 300 may be similar to the memory blocks shown and described with respect to FIG. 2A – FIG. 2B. In addition, each of the memory blocks may be associated with one or more memory dies of a memory device such as, for example, the first memory die 165 and/or the second memory die 170 of the memory device 155 shown and described with respect to FIG. 1.

In the example shown, the pool of memory blocks 300 includes a first memory block 310, a second memory block 325 and a Nth memory block 340. Although N memory block are shown, the pool of memory blocks 300 may have any number of memory blocks. In an example, each memory block has two sub-blocks and each sub-block is associated with a validity count.

For example, the first memory block 310 has a first sub-block 315 and a second sub-block 320. The first sub-block 315 has a validity count (VC) of 400 and the second sub-block 320 has a validity count of 10. Additionally, in this example, the second memory block 325 has a first sub-block 330 with a validity count of 15 and a second sub-block 335 having a validity count of 20. The Nth memory block 340 has a first sub-block 345 and a second sub-block 350. The first sub-block 345 has a validity count of 30 and the second sub-block 350 has a validity count of 32. Although specific values are given, these are for example purposes only.

As previously described, when a garbage collection operation and/or a relocation operation is to be performed, a sub-block management system (e.g., the sub-block management system 180 (FIG. 1)) analyzes the memory blocks in the pool of the memory blocks 300 to determine which sub-block has the lowest validity count. In this example, the sub-block management system determines that second sub-block 320 (having a validity count of 10) of the first memory block 310 has the lowest validity count of all the sub-blocks in the pool of memory blocks 300.

The sub-block management system then determines or identifies a validity count of the sister sub-block of the sub-block with the lowest validity count. For example, the sub-block management system will determine that the first sub-block 315 of the first memory block 310 is the sister sub-block of the second sub-block 320. As such, the sub-block management system will determine that the validity count of the first sub-block 315 is 400.

The sub-block management system then determines a difference between the validity count of the first sub-block 315 and the second sub-block 320. The sub-block management system will then determine whether the difference in validity count between the two sub-blocks is within a validity count difference threshold.

In this example, the validity count difference threshold is 20. Although 20 is specifically mentioned, the validity count difference threshold can be any number. Additionally, the validity count difference threshold can be static or dynamic. For example, the validity count difference threshold may be based on a number of program/erase (P/E) cycles associated with the memory block and/or the sub-block(s).

In an example, the purpose of the various operations described herein is to save an erase time of a sub-block. Thus, when two sub-blocks are erased together, there is an advantage over current solutions. For example, if it typically takes 5 milliseconds (ms) to erase a memory block, any extra workload associated with a garbage collection operation that is to be done on both sub-blocks together should be such that the latency is less than the erase time of 5ms. Thus, a validity count difference denotes extra garbage collection workload. As such, in an example, a validity count threshold should be selected such that any gains are based, at least in part, with this in mind given the erase latency that is intended to be optimized.

Returning to the example, the difference in the validity count between the first sub-block 315 of the first memory block 310 and the second sub-block 320 of the first memory block 310 is 390 (e.g., mod(400 – 10) = 390). The sub-block management system determines that 390 is greater than the validity count difference threshold. As such, the second sub-block 320 of the first memory block 310 is selected for the garbage collection operation and/or the relocation operation and the first sub-block 315 is omitted.

In another example, the sub-block management system may select one or more memory blocks for the garbage collection operation and/or the relocation operation based, at least in part, on whether the validity counts of the different sub-blocks are within the validity count difference threshold – even if the sub-blocks do not have the lowest validity count.

For example, the sub-block management system determines that the sub-blocks of the second memory block 325 have a difference in a validity count that is within the validity count difference threshold. For example, the first sub-block 330 of the second memory block 325 has a validity count of 15 and the second sub-block 335 of the second memory block 325 has a validity count of 20. As such, the difference in validity count between the sub-blocks is 5 (e.g., mod(15 – 20) = 5) – which is within the validity count difference threshold of 20 in this example.

Because the difference in the validity counts of the sub-blocks of the second memory block 325 is within the validity count difference threshold, the sub-block management system may prioritize the second memory block 325 over the first memory block 310. As such, the sub-block management system causes the garbage collection operation and/or the relocation operation to be performed on the first sub-block 330 of the second memory block 325 and the second sub-block 335 of the second memory block 325.

In an example, the prioritization of the second memory block 325 over the first memory block 310 may be based, at least in part, on an operating state of the data storage device. For example, if the data storage device is storing over a threshold amount of data (or has under a threshold amount of available space), the sub-block management system may prioritize freeing up entire memory blocks when compared to freeing up a single sub-block.

In another example, the sub-block management system may determine that although the first sub-block 330 of the second memory block 325 does not have the lowest validity count, a difference between the validity count of the first sub-block 330 of the second memory block 325 and the validity count of the second sub-block 320 of the first memory block 310 is within a lowest validity count difference threshold. For example, the difference between the validity count of the first sub-block 330 of the second memory block 325 and the validity count of the second sub-block 320 of the first memory block 310 is 5 (e.g., mod(10 – 15) = 5). Because 5 is within the lowest validity count difference threshold, the sub-block management system determines to execute the garbage collection operation and/or the relocation operation on the second memory block 325.

In an example, the lowest validity count difference threshold may be any number and may be static or dynamic. Additionally, the lowest validity count difference threshold may be based, at least in part, on an operating state of the data storage device, a number of P/E cycles associated with a memory block and/or one or more sub-blocks and/or other factors. In examples in which a determination is made to perform a garbage collection operation on multiple sub-blocks together, the sub-block management system may additionally check whether the total validity count is less than a total validity count of competing/other memory blocks that are up for garbage collection operations. In some examples, if the validity count of the other memory blocks is less, the other memory block(s) may be selected.

Continuing with the example, the sub-block management system may also determine that the difference in validity count of the sub-blocks of the Nth memory block 340 are within the validity count difference threshold. For example, the sub-block management system determines that the difference in validity count between the first sub-block 345 and the second sub-block 350 of the Nth memory block 340 is 2 (e.g., mod(30 – 32) = 2).

Because the difference in validity counts is less than the validity count difference threshold, the sub-block management system may select or prioritize the Nth memory block 340 over the first memory block 310 for the garbage collection operation and/or the relocation operation. Additionally, because the difference in validity counts of the sub-blocks of the Nth memory block 340 is less than the difference of validity counts of the sub-blocks of the second memory block 325 (e.g., 2 is less than 5), the sub-block management system may prioritize the Nth memory block 340 over the second memory block 325.

However, in another example, the difference between the validity count of the first sub-block 345 of the Nth memory block 340 and the validity count of the second sub-block 320 of the first memory block 310 (e.g., the sub-block with the lowest validity count) may be above the lowest validity count difference threshold. For example, the difference between the validity count of the first sub-block 345 of the Nth memory block 340 and the validity count of the second sub-block 320 of the first memory block 310 is 20 (e.g., mod(30 – 10) = 20), which may be above the lowest validity count difference threshold. As such, the sub-block management system would not prioritize the Nth memory block 340 over one or more of the first memory block 310 and/or the second memory block 325.

FIG. 4 illustrates how one or more characteristics of data associated with a source memory block is used to select a destination memory block according to an example. In example, the source memory blocks are the memory blocks that are in the pool of memory blocks 300 shown and described with respect to FIG. 3. For example, the first memory block 310 and the second memory block 325 were identified as candidates for a garbage collection operation and/or a relocation operation such as previously described.

In an example, the data stored by each of the sub-blocks in the pool of memory blocks 300 is associated with one or more characteristics. For example, the first sub-block 315 of the first memory block 310 stores random data and the data is cold. Additionally, the second sub-block 320 of the first memory block 310 stores random data and the data is hot.

Using these characteristics, a sub-block management system (e.g., the sub-block management system 180 (FIG. 1)) determines the destination memory block to which the data associated with the second sub-block 320 should be relocated. For example, the sub-block management system may identify a pool of destination memory blocks 400 that includes a number of destination memory blocks. In this example, the pool of destination memory blocks 400 includes M destination memory blocks and each destination memory block includes at least two sub-blocks. In an example, some of the destination memory blocks are empty while some of the destination memory blocks are at least partially full or otherwise store data.

For example, the first sub-block 415 of the first destination memory block 410 is at least partially full with random/hot data. However, the second sub-block 420 of the first destination memory block 410 is empty. Additionally, the first sub-block 430 of the second destination memory block 425 is at least partially full with sequential/hot data. However, the second sub-block 435 of the second destination memory block 425 is empty. In this example, the Mth destination memory block 440 is completely empty. That is, the first sub-block 445 and the second sub-block 450 of the Mth destination memory block 440 are not storing any data.

Using this information the sub-block management system determines to relocate valid data associated with the second sub-block 320 of the first memory block 310 to the second sub-block 420 of the first destination memory block 410 (e.g., when the second sub-block 320 of the first memory block 310 is selected for the garbage collection operation). As previously discussed, the sub-block management system selects the first destination memory block 410 because the first destination memory block 410 is already storing random/hot data.

Likewise, the sub-block management system determines to relocate valid data associated with the second memory block 325 (e.g., valid data from both the first sub-block 330 and the second sub-block 335) to the second sub-block 435 associated with the second destination memory block 425. This selection is made because the first sub-block 430 of the second destination memory block 425 is storing the same type of data (e.g., sequential/hot data) as the first sub-block 330 and the second sub-block 335 of the second memory block 325.

In another example, the sub-block management system may select the Mth destination memory block 440 if none of the destination memory blocks stores data with the same characteristics as the data being relocated and/or if a destination memory block does not have enough room to store the relocated data. For example, the sub-block management system may select the Mth destination memory block 440 to store data from the second memory block 325 if the first sub-block 430 of the second destination memory block 425 was not storing sequential/hot data.

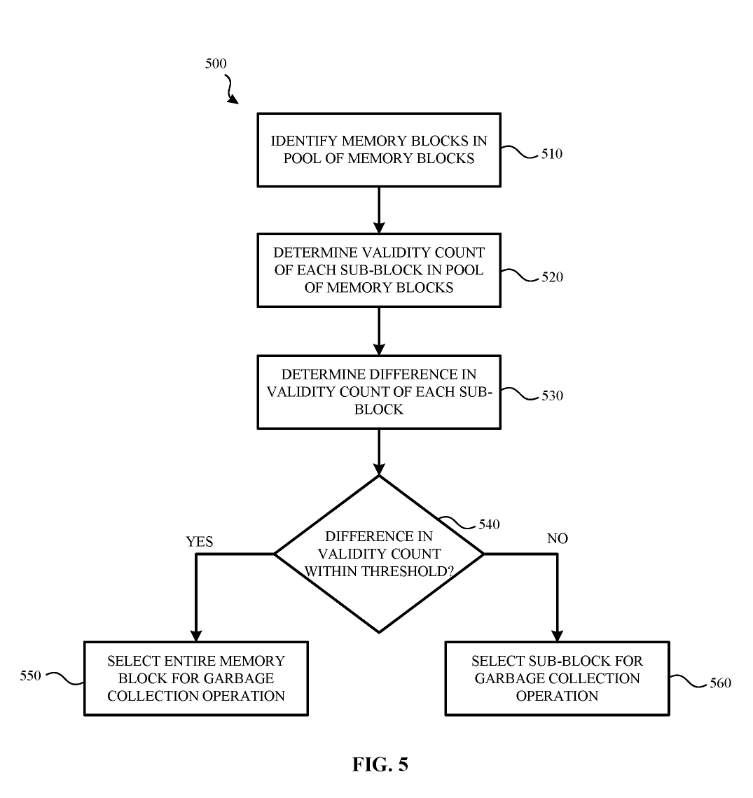

FIG. 5 illustrates a method 500 for performing a garbage collection operation on one or more sub-blocks of a memory block according to an example. In an example, the method 500 is performed by a sub-block management system of a data storage device such as, for example, the sub-block management system 180 shown and described with respect to FIG. 1.

In an example, the method 500 begins when a garbage collection operation (or a relocation operation) is initiated. When the garbage collection operation is initiated, the sub-block management system identifies (510) one or more memory blocks in a pool of memory blocks that have been identified as candidates for the garbage collection operation. In an example, the memory blocks in the pool of memory blocks are partitioned into two or more sub-blocks. Additionally, each sub-block is associated with a validity count that indicates an amount of valid data stored in the sub-block.

When the pool of memory blocks has been identified, the sub-block management system determines (520) the validity count of each sub-block of each of the memory blocks in the pool of memory blocks. As part of this operation, the sub-block management system may also determine or identify the sub-block with the lowest validity count. In an example, the sub-block management system may also determine one or more characteristics of data stored by each of the sub-blocks and/or determine one or more characteristics of data stored by the sub-block with the lowest validity count.

In an example, when the validity count of each sub-block has been identified, or when the sub-block with the lowest validity count has been identified, the sub-block management system also determines (530) a difference in validity count between each sub-block of each memory block. In another example, such as when the sub-block with the lowest validity count has been identified, the sub-block management system determines a difference in validity count between the sub-block and its sister sub-block.

The sub-block management system then determines (540) whether the difference in validity counts is within a validity count difference threshold. If the sub-block management system determines (540) that the difference in validity counts is within the validity count difference threshold, the sub-block management system selects (550) the entire memory block (e.g., both/all sub-blocks) for the garbage collection operation. However, if the sub-block management system determines (540) that the difference in validity counts exceeds the validity count difference threshold, the sub-block management system selects (560) the sub-block with the lowest validity count for the garbage collection operation.

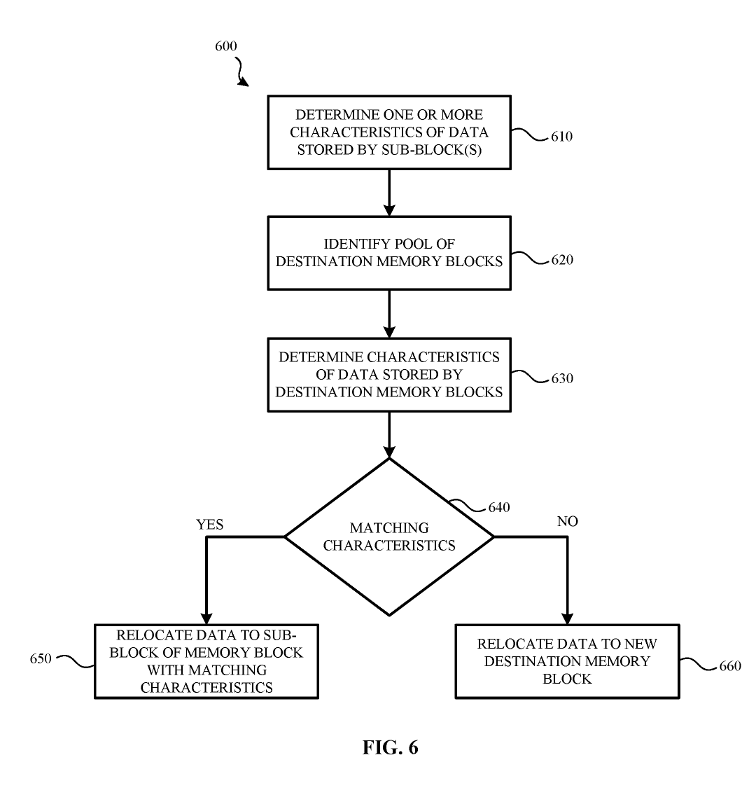

FIG. 6 illustrates a method 600 for selecting a destination memory block as part of a garbage collection operation according to an example. In an example, the method 600 is performed by a sub-block management system of a data storage device such as, for example, the sub-block management system 180 shown and described with respect to FIG. 1. Additionally, the method 600 may be performed as part of, or in addition to, the method 500 shown and described with respect to FIG. 5.

In an example, the method 600 begins when the sub-block management system determines one or more characteristics of data stored by a sub-block (or multiple sub-blocks) that have been selected for garbage collection operation (or a relocation operation). In an example, the sub-block was selected for the garbage collection operation based, at least in part, on a validity count associated with the sub-block.

Based, at least in part, on the sub-block has been selected and the one or more characteristics of the data having been determined, the sub-block management system identifies (620) a pool of destination memory blocks. In an example, each memory block in the pool of destination memory blocks is comprised of two or more sub-blocks. Some of the sub-blocks may already have data stored therein and some of the sub-blocks may be empty.

The sub-block management system then determines (630) one or more characteristics of data stored by the sub-blocks in the pool of destination memory blocks. However, in some examples and as previously discussed, some memory blocks in the pool of destination memory blocks are entirely empty.

The sub-block management system also determines (640) whether data in a sub-block of a memory block in the pool of destination memory blocks has matching characteristics as the data in the source memory block (e.g., the memory block and/or the sub-block(s) that was/were selected for the garbage collection operation). If the sub-block management system determines (640) that the one or more characteristics match, the sub-block management system relocates (650) the data from the source memory block to the memory block having the matching characteristics. However, if the sub-block management system determines (640) that the one or more characteristics do not match, the sub-block management system relocates (660) the data from the source memory block to an empty/new destination memory block.

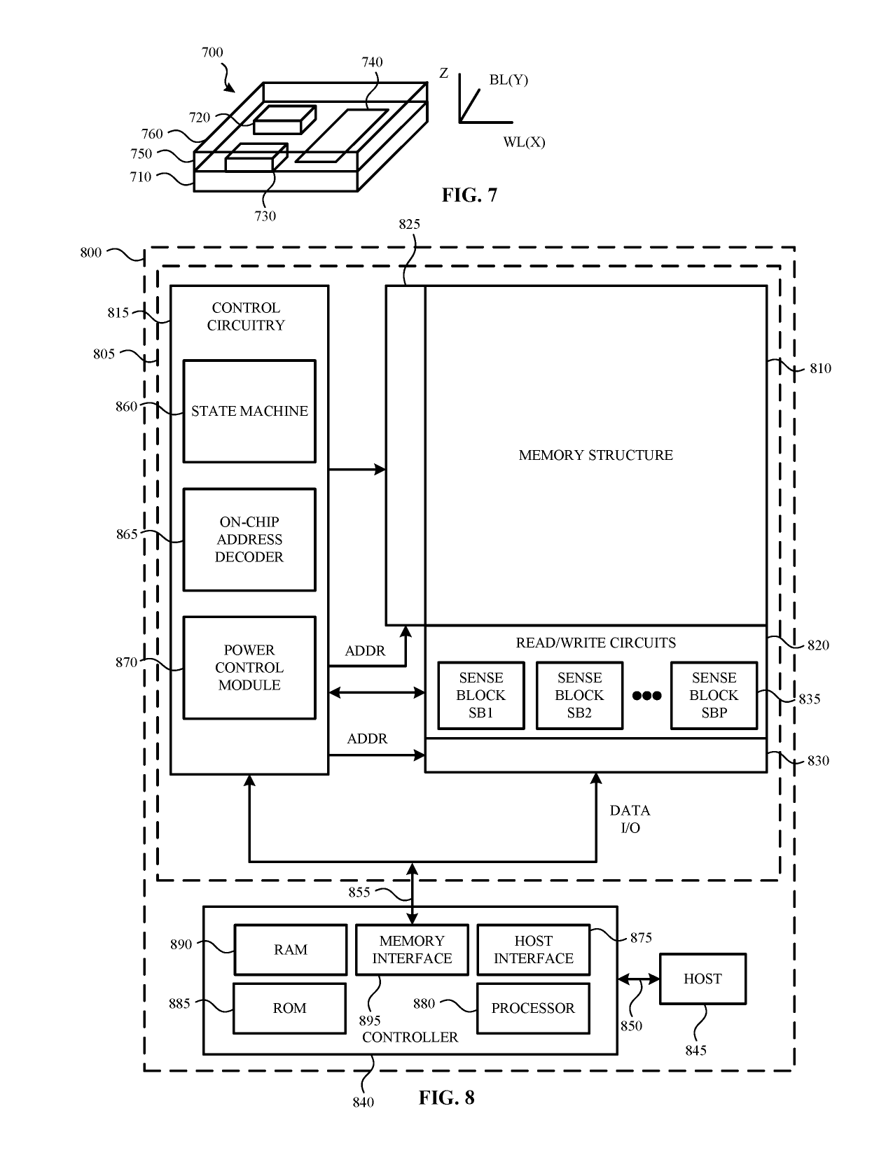

FIG. 7 – FIG. 8 describe example storage devices that may be used with or otherwise implement the various features described herein. For example, the storage devices shown and described with respect to FIG. 7 – FIG. 8 may include various systems and components that are similar to the systems and components shown and described with respect to FIG. 1. For example, the controller 840 shown and described with respect to FIG. 8 may be similar to the controller 150 of FIG. 1. Likewise, the memory dies 805 may be similar to the first memory die 165 and/or the second memory die 170 of FIG. 1.

FIG. 7 is a perspective view of a storage device 700 that includes three-dimensional (3D) stacked non-volatile memory according to an example. In this example, the storage device 700 includes a substrate 710. Blocks of memory cells are included on or above the substrate 710. The blocks may include a first block 720 (BLK0) and a second block 730 (BLK1). Each block may be formed of memory cells (e.g., non-volatile memory elements). The substrate 710 may also include a peripheral area 740 having support circuits that are used by the first block 720 and the second block 730. The peripheral area 740 may be located beneath the first block 720 and the second block 730. In another example, the peripheral area may be included on a different substrate or die.

The substrate 710 may also carry circuits under the blocks, along with one or more lower metal layers which are patterned in conductive paths to carry signals from the circuits. The blocks may be formed in an intermediate region 750 of the storage device 700. The storage device may also include an upper region 760. The upper region 760 may include one or more upper metal layers that are patterned in conductive paths to carry signals from the circuits. Each block of memory cells may include a stacked area of memory cells. In an example, alternating levels of the stack represent wordlines. While two blocks are depicted, additional blocks may be used and extend in the x-direction and/or the y-direction.

In an example, a length of a plane of the substrate 710 in the x-direction represents a direction in which signal paths for wordlines or control gate lines extend (e.g., a wordline or drain-end select gate (SGD) line direction) and the width of the plane of the substrate 710 in the y-direction represents a direction in which signal paths for bit lines extend (e.g., a bit line direction). The z-direction represents a height of the storage device 700.

FIG. 8 is a functional block diagram of a storage device 800 according to an example. In an example, the storage device 800 may be the 3D stacked non-volatile storage device 700 shown and described with respect to FIG. 7. The components depicted in FIG. 8 may be electrical circuits. In an example, the storage device 800 includes one or more memory dies 805. Each memory die 805 includes a three-dimensional memory structure 810 of memory cells (e.g., a 3D array of memory cells), control circuitry 815, and read/write circuits 820. In another example, a two-dimensional array of memory cells may be used. The memory structure 810 is addressable by wordlines using a first decoder 825 (e.g., a row decoder) and by bit lines using a second decoder 830 (e.g., a column decoder). The read/write circuits 820 may also include multiple sense blocks 835 including SB1, SB2, . . ., SBp (e.g., sensing circuitry) which allow pages of the memory cells to be read or programmed in parallel. The sense blocks 835 may include bit line drivers.

In an example, a controller 840 is included in the same storage device 800 as the one or more memory dies 805. In another example, the controller 840 is formed on a die that is bonded to a memory die 805, in which case each memory die 805 may have its own controller 840. In yet another example, a controller die controls all of the memory dies 805.

Commands and data may be transferred between a host 845 and the controller 840 using a data bus 850. Commands and data may also be transferred between the controller 840 and one or more of the memory dies 805 by way of lines 855. In one example, the memory die 805 includes a set of input and/or output (I/O) pins that connect to lines 855.

The memory structure 810 may also include one or more arrays of memory cells. The memory cells may be arranged in a three-dimensional array or a two-dimensional array. The memory structure 810 may include any type of non-volatile memory that is formed on one or more physical levels of arrays of memory cells having an active area disposed above a silicon substrate. The memory structure 810 may be in a non-volatile memory device having circuitry associated with the operation of the memory cells, whether the associated circuitry is above or within the substrate.

The control circuitry 815 works in conjunction with the read/write circuits 820 to perform memory operations (e.g., erase, program, read, and others) on the memory structure 810. The control circuitry 815 may include registers, ROM fuses, and other devices for storing default values such as base voltages and other parameters.

The control circuitry 815 may also include a state machine 860, an on-chip address decoder 865, and a power control module 870. The state machine 860 may provide chip-level control of various memory operations. The state machine 860 may be programmable by software. In another example, the state machine 860 does not use software and is completely implemented in hardware (e.g., electrical circuits).

The on-chip address decoder 865 may provide an address interface between addresses used by host 845 and/or the controller 840 to a hardware address used by the first decoder 825 and the second decoder 830.

The power control module 870 may control power and voltages that are supplied to the wordlines and bit lines during memory operations. The power control module 870 may include drivers for wordline layers in a 3D configuration, select transistors (e.g., SGS and SGD transistors) and source lines. The power control module 870 may include one or more charge pumps for creating voltages.

The control circuitry 815, the state machine 860, the on-chip address decoder 865, the first decoder 825, the second decoder 830, the power control module 870, the sense blocks 835, the read/write circuits 820, and/or the controller 840 may be considered one or more control circuits and/or a managing circuit that perform some or all of the operations described herein.

In an example, the controller 840, is an electrical circuit that may be on-chip or off-chip. Additionally, the controller 840 may include one or more processors 880, ROM 885, RAM 890, memory interface 895, and host interface 875, all of which may be interconnected. In an example, the one or more processors 880 is one example of a control circuit. Other examples can use state machines or other custom circuits designed to perform one or more functions. Devices such as ROM 885 and RAM 890 may include code such as a set of instructions. One or more of the processors 880 may be operable to execute the set of instructions to provide some or all of the functionality described herein.

Alternatively or additionally, one or more of the processors 880 may access code from a memory device in the memory structure 810, such as a reserved area of memory cells connected to one or more wordlines. The memory interface 895, in communication with ROM 885, RAM 890, and one or more of the processors 880, may be an electrical circuit that provides an electrical interface between the controller 840 and the memory die 805. For example, the memory interface 895 may change the format or timing of signals, provide a buffer, isolate from surges, latch I/O, and so forth.

The one or more processors 880 may issue commands to control circuitry 815, or any other component of memory die 805, using the memory interface 895. The host interface 875, in communication with the ROM 885, the RAM 890, and the one or more processors 880, may be an electrical circuit that provides an electrical interface between the controller 840 and the host 845. For example, the host interface 875 may change the format or timing of signals, provide a buffer, isolate from surges, latch I/O, and so on. Commands and data from the host 845 are received by the controller 840 by way of the host interface 875. Data sent to the host 845 may be transmitted using the data bus 850.

Multiple memory elements in the memory structure 810 may be configured so that they are connected in series or so that each element is individually accessible. By way of a non-limiting example, flash memory devices in a NAND configuration (e.g., NAND flash memory) typically contain memory elements connected in series. A NAND string is an example of a set of series-connected memory cells and select gate transistors.

A NAND flash memory array may also be configured so that the array includes multiple NAND strings. In an example, a NAND string includes multiple memory cells sharing a single bit line and are accessed as a group. Alternatively, memory elements may be configured so that each memory element is individually accessible (e.g., a NOR memory array). The NAND and NOR memory configurations are examples and memory cells may have other configurations.

The memory cells may be arranged in the single memory device level in an ordered array, such as in a plurality of rows and/or columns. However, the memory elements may be arrayed in non-regular or non-orthogonal configurations, or in structures not considered arrays.

In an example, a 3D memory structure may be vertically arranged as a stack of multiple 2D memory device levels. As another non-limiting example, a 3D memory array may be arranged as multiple vertical columns (e.g., columns extending substantially perpendicular to the major surface of the substrate, such as in the y direction) with each column having multiple memory cells. The vertical columns may be arranged in a two-dimensional arrangement of memory cells, with memory cells on multiple vertically stacked memory planes. Other configurations of memory elements in three dimensions can also constitute a 3D memory array.

In another example, in a 3D NAND memory array, the memory elements may be coupled together to form vertical NAND strings that traverse across multiple horizontal memory device levels. Other 3D configurations can be envisioned wherein some NAND strings contain memory elements in a single memory level while other strings contain memory elements which span through multiple memory levels. 3D memory arrays may also be designed in a NOR configuration and in a RAM configuration.

In accordance with the various examples described herein, examples of the present disclosure describe a method, comprising: identifying a plurality of memory blocks that have been selected for a garbage collection operation, each memory block of the plurality of memory blocks being divided into two or more sub-blocks; selecting at least one memory block from the plurality of memory blocks for the garbage collection operation; determining a first validity count associated with a first sub-block of the at least one memory block; determining a second validity count associated with a second sub-block of the at least one memory block; determining whether a difference between the first validity count associated with the first sub-block and the second validity count associated with the second sub-block is within a validity count difference threshold; and performing the garbage collection operation on the first sub-block and the second sub-block when the difference between the first validity count associated with the first sub-block and the second validity count associated with the second sub-block is within the validity count difference threshold. In an example, the method also includes performing the garbage collection operation on the first sub-block when the difference between the first validity count associated with the first sub-block and the second validity count associated with the second sub-block exceeds the validity count difference threshold and when the first sub-block has a lower validity count when compared with the second sub-block. In an example, the method also includes identifying at least one characteristic associated with data stored in the first sub-block. In an example, the method also includes selecting a destination memory block for the garbage collection operation based, at least in part, on the at least one characteristic. In an example, the destination memory block comprises a first sub-block and a second sub-block and wherein at least one of the first sub-block and the second sub-block store data having the at least one characteristic. In an example, one of the first sub-block and the second sub-block are full. In an example, the method also includes selecting an empty destination memory block based, at least in part, on determining a sub-block of an available destination memory block stores data having a characteristic that is different from the at least one characteristic associated with the data stored in the first sub-block. In an example, the at least one memory block is selected from the plurality of memory blocks based, at least in part, on the first validity count associated with the first sub-block of the at least one memory block. In an example, the at least one memory block is selected from the plurality of memory blocks based, at least in part, on the first validity count associated with the first sub-block of the at least one memory block and the second validity count associated with the second sub-block of the at least one memory block.

Examples also describe a data storage device, comprising: at least one controller; and a sub-block management system associated with the at least one controller and operable to: select a memory block for a relocation operation, the memory block being part of a pool of memory blocks that have been identified as candidates for the relocation operation; determine a first validity count associated with a first sub-block of the memory block; determine a second validity count associated with a second sub-block of the memory block; determine a difference between the first validity count and the second validity count; and perform the relocation operation on one of the first sub-block and the second sub-block when a difference between the first validity count and the second validity count exceeds a validity count difference threshold. In an example, the sub-block management system is further operable to perform the relocation operation on the first sub-block and the second sub-block when the difference between the first validity count and the second validity count is within the validity count difference threshold. In an example, the sub-block management system is further operable to perform the relocation operation on the first sub-block when the first sub-block has a lower validity count when compared with the second sub-block. In an example, the sub-block management system is further operable to identify at least one characteristic associated with data stored in the first sub-block. In an example, the sub-block management system is further operable to select a destination memory block for the relocation operation based, at least in part, on the at least one characteristic. In an example, the destination memory block comprises a first sub-block and a second sub-block and wherein at least one of the first sub-block and the second sub-block store data having the at least one characteristic. In an example, the sub-block management system is further operable to select an empty destination memory block based, at least in part, on a determination that a sub-block of an available destination memory block stores data having a characteristic that is different from the at least one characteristic associated with the data stored in the first sub-block.

Other examples describe a data storage device, comprising: means for selecting a memory block from a pool of memory blocks for a garbage collection operation; means for determining a first validity count associated with a first sub-block of the memory block; means for determining a second validity count associated with a second sub-block of the memory block; means for determining a difference between the first validity count and the second validity count; and means for performing the garbage collection operation on the first sub-block and the second sub-block when a difference between the first validity count and the second validity count is within a validity count difference threshold. In an example, the data storage device also includes means for performing the garbage collection operation on one of the first sub-block and the second sub-block when the difference between the first validity count and the second validity count exceeds the validity count difference threshold. In an example, the garbage collection operation is performed on the first sub-block when the first sub-block has a lower validity count when compared with the second sub-block. In an example, the data storage device also includes means for identifying at least one characteristic associated with data stored in at least one of the first sub-block and the second sub-block.

One of ordinary skill in the art will recognize that the technology described herein is not limited to a single specific memory structure, but covers many relevant memory structures within the spirit and scope of the technology as described herein and as understood by one of ordinary skill in the art.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

References to an element herein using a designation such as "first," "second," and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

What is claimed is:

1. A method, comprising:
identifying a plurality of memory blocks that have been selected for a garbage collection operation, each memory block of the plurality of memory blocks being divided into two or more sub-blocks;
selecting at least one memory block from the plurality of memory blocks for the garbage collection operation;
determining a first validity count associated with a first sub-block of the at least one memory block;
determining a second validity count associated with a second sub-block of the at least one memory block;
determining whether a difference between the first validity count associated with the first sub-block and the second validity count associated with the second sub-block is within a validity count difference threshold; and
performing the garbage collection operation on the first sub-block and the second sub-block when the difference between the first validity count associated with the first sub-block and the second validity count associated with the second sub-block is within the validity count difference threshold.

2. The method of claim 1, further comprising performing the garbage collection operation on the first sub-block when the difference between the first validity count associated with the first sub-block and the second validity count associated with the second sub-block exceeds the validity count difference threshold and when the first sub-block has a lower validity count when compared with the second sub-block.

3. The method of claim 2, further comprising identifying at least one characteristic associated with data stored in the first sub-block.

4. The method of claim 3, further comprising selecting a destination memory block for the garbage collection operation based, at least in part, on the at least one characteristic.

5. The method of claim 4, wherein the destination memory block comprises a first sub-block and a second sub-block and wherein at least one of the first sub-block and the second sub-block store data having the at least one characteristic.

6. The method of claim 5, wherein one of the first sub-block and the second sub-block are full.

7. The method of claim 3, further comprising selecting an empty destination memory block based, at least in part, on determining a sub-block of an available destination memory block stores data having a characteristic that is different from the at least one characteristic associated with the data stored in the first sub-block.

8. The method of claim 1, wherein the at least one memory block is selected from the plurality of memory blocks based, at least in part, on the first validity count associated with the first sub-block of the at least one memory block.

9. The method of claim 1, wherein the at least one memory block is selected from the plurality of memory blocks based, at least in part, on the first validity count associated with the first sub-block of the at least one memory block and the second validity count associated with the second sub-block of the at least one memory block.

10. A data storage device, comprising:
at least one controller; and
a sub-block management system associated with the at least one controller and operable to:
select a memory block for a relocation operation, the memory block being part of a pool of memory blocks that have been identified as candidates for the relocation operation;
determine a first validity count associated with a first sub-block of the memory block;
determine a second validity count associated with a second sub-block of the memory block;
determine a difference between the first validity count and the second validity count; and
perform the relocation operation on one of the first sub-block and the second sub-block when a difference between the first validity count and the second validity count exceeds a validity count difference threshold.

11. The data storage device of claim 10, wherein the sub-block management system is further operable to perform the relocation operation on the first sub-block and the second sub-block when the difference between the first validity count and the second validity count is within the validity count difference threshold.

12. The data storage device of claim 10, wherein the sub-block management system is further operable to perform the relocation operation on the first sub-block when the first sub-block has a lower validity count when compared with the second sub-block.

13. The data storage device of claim 12, wherein the sub-block management system is further operable to identify at least one characteristic associated with data stored in the first sub-block.

14. The data storage device of claim 13, wherein the sub-block management system is further operable to select a destination memory block for the relocation operation based, at least in part, on the at least one characteristic.

15. The data storage device of claim 14, wherein the destination memory block comprises a first sub-block and a second sub-block and wherein at least one of the first sub-block and the second sub-block store data having the at least one characteristic.

16. The data storage device of claim 13, wherein the sub-block management system is further operable to select an empty destination memory block based, at least in part, on a determination that a sub-block of an available destination memory block stores data having a characteristic that is different from the at least one characteristic associated with the data stored in the first sub-block.

17. A data storage device, comprising:
means for selecting a memory block from a pool of memory blocks for a garbage collection operation;
means for determining a first validity count associated with a first sub-block of the memory block;
means for determining a second validity count associated with a second sub-block of the memory block;
means for determining a difference between the first validity count and the second validity count; and
means for performing the garbage collection operation on the first sub-block and the second sub-block when a difference between the first validity count and the second validity count is within a validity count difference threshold.

18. The data storage device of claim 17, further comprising means for performing the garbage collection operation on one of the first sub-block and the second sub-block when the difference between the first validity count and the second validity count exceeds the validity count difference threshold.

19. The data storage device of claim 18, wherein the garbage collection operation is performed on the first sub-block when the first sub-block has a lower validity count when compared with the second sub-block.

20. The data storage device of claim 17, further comprising means for identifying at least one characteristic associated with data stored in at least one of the first sub-block and the second sub-block.
